(19) United States
(12) Patent Application Publication
(10) Pub. No.: US 2017/0050304 A1
(43) Pub. Date: Feb. 23, 2017

(54) BARREL ASSEMBLY OF A NAIL GUN

(71) Applicant: Wen-Sheng Huang, Taichung City (TW)

(72) Inventor: Wen-Sheng Huang, Taichung City (TW)

(21) Appl. No.: 14/830,721

(22) Filed: Aug. 19, 2015

(51) Int. Cl. B25C 1/04

(52) U.S. Cl. CPC B25C 1/047

(57) ABSTRACT

A barrel assembly of a nail gun comprises a sleeve member, a cover member, a bush, and a firing pin. The sleeve member is connected with the gun body and includes a chamber, a firing hole, and a transporting portion. The cover member is covered at the end of the sleeve member having the firing hole. Two ends of the bush are respectively inserted into the fireproof groove and protruded from the cover member. A limit hole is passing through the bush for fluidly communicating with the firing hole. Two ends of the firing pin are respectively connected with the gun body and inserted into the chamber of the sleeve member. The gun body is operated to drive the firing pin to shift in the chamber, and further firing the nails through the firing hole toward the limit hole of the bush to send out.

### BACKGROUND OF THE INVENTION

1. Field of the Invention

The present invention relates to a barrel assembly of a nail gun, and especially relates to a pneumatic tools for shooting nails with high speed. The main skill is that a bush is arranged in the barrel assembly to improve the disassembly and replacement of the barrel and further keep the operation of nailing smooth.

2. Description of Related Art

The conventional nail gun may be show as in FIG. 11. The nail gun mainly comprises a gun body and a driving head 5. a barrel 51 and a firing pin 52 may be arranged inside the driving head 5. The firing pin 52 is passing through the barrel 51 and controlled by the gun body 51 to flexibly fire. A safety cover member 6 is arranged at the side of the barrel 51 opposite to the gun body. The safety cover member 6 is covering the barrel 51. A fireproof cover 61 is formed at the end of the safety cover member 6 which is shooting out the nails. After the nails loads from the outside of the driving head 5 to the end of the barrel 51 which is connected to the gun body, the gun body drives the firing pin 52 to expand and contract continuously. When the firing pin 52 is contracted toward the gun body, the nails are controlled to force into the barrel 51. After the nails are totally forced into the barrel 51, the firing pin 52 may collide with the nails directly so that the nails are shot out toward the fireproof cover 61 along the barrel 51. And the operation of shooting is finished.

However, the length of barrel of the conventional nail gun may be set much longer due to keeping the precise shoot in the shooting path. But the nails are made by metal materials and the barrel is made by mild steel. Because the wearing resistance of the mild steel is not good enough, the nails may be rubbed with the barrel in high speed to generate heat with high temperature. The instant high temperature is easily resulting in expansion of the barrel so that the nails may not be shot straightly while the nails are fired by the firing pin. Besides, the replacement of the barrel of the conventional nail gun is more multifarious. That is, the disassembly of the elements of the conventional nail gun must be finished one by one from outside to inside. In other words, the assembly of the elements of the conventional nail gun must be also finished one by one and take long time. If some of the elements is lost after assembling or the elements are misassembled, the conventional nail gun will not work normally, even the nails are shot obliquely. Therefore, the conventional nail gun may not provide stable use.

In view of the foregoing circumstances, the inventor has invested a lot of time to study the relevant knowledge, compare the pros and cons, research and develop related products. After quite many experiments and tests, the “barrel assembly” of this invention is eventually launched to improve the foregoing shortcomings, to meet the public use.

### SUMMARY OF THE INVENTION

An object of this invention is providing a barrel assembly of a nail fun for providing the nails to keep precision and accuracy while shooting and preventing from shooting obliquely due to the issue of the barrel. And then, for the operation of assembly and disassembly, the elements may be easily and quickly replaced by users for saving more time. It may improve the issues of multifarious operation and wasting time and energy for disassembling and replacing the conventional nail gun. And the issues of deformation of the barrel due to overheating by rubbing with the nails and imprecisely shooting of the nails may be improved.

In order to achieve above mentioned effects, a barrel assembly of a nail gun installed at a front end of a gun body for transporting nails is provided. The barrel assembly may comprise a sleeve member, connected with the front end of the gun body, the sleeve member includes a chamber, a firing hole, and a transporting portion, the firing hole is arranged at an end of the sleeve member opposite to the gun body and fluidly communicated with the chamber, the transporting portion is arranged at a peripheral of the chamber, and a nail receiving groove is further formed inside the transporting portion for fluidly communicating with the chamber and for receiving the nails; a cover member, covered at the end of the sleeve member having the firing hole, an end of the cover member corresponding to the firing hole is further protruded from the sleeve member, and a fireproof groove is formed at the cover member corresponding to the firing hole of the sleeve member; a bush, two ends thereof are respectively inserted into the fireproof groove and protruded from the cover member, a limit hole is further passing through the bush for fluidly communicating with the firing hole, and the end of the sleeve member having the firing hole is inserted into the limit hole; and a firing pin, two ends thereof are respectively connected with the gun body and inserted into the chamber of the sleeve member, the gun body is operated to drive the firing pin to shift in the chamber, and further firing the nails through the firing hole toward the limit hole of the bush to send out.

In some embodiments, a ring conical surface is formed at an inner wall of the limit hole of the bush corresponding to the firing hole, a diameter of the end of the limit hole corresponding to the firing hole is larger than the other end thereof opposite to the firing hole, and the end of the sleeve member having the firing hole is against the ring conical surface to limit the expansion of the firing hole.

In some embodiments, an connection between the bush and the cover member is screwing, engagement, or magnetic adhesion.

In some embodiments, an outer thread is formed at a peripheral of one end of the bush inserted into the fireproof groove, and an inner thread is formed at the fireproof groove corresponding to the outer thread for screwing with each other.

In some embodiments, a flange is formed at a peripheral of one end of the bush inserted into the fireproof groove, and a slot is formed at the fireproof groove corresponding to the flange for engaging with each other.

In conclusion, the deformation of the firing hole may be limited due to the arrangements of the bush and the limit hole with the ring conical surface. Therefore, after the nails is fired by the firing pin which is controlled by the gun body, the nails may be shot in the best path and direction, and further achieve the most precision and most stable shooting. Besides preventing from the deformation of the firing hole, it further provides easy replacement. Users may disassemble the bush from the fireproof groove to finish the disassembly. Compared to the conventional nail fun, the complicated disassembly is improved and the more time and man power are saved.

The various objectives and advantages of the present invention will be more readily understood from the following detailed description when read in conjunction with the appended drawing.

### BRIEF DESCRIPTION OF THE DRAWINGS

FIG. 1 is a perspective view of a barrel assembly of a nail gun of the present invention which is installed at a gun body;

FIG. 2 is a partial enlarged view of FIG. 1;

FIG. 3 is an exploded view of FIG. 2;

FIG. 4 is a cross-sectional view of FIG. 2 along line IV-IV;

FIGS. 5 and 6 are operational views of the barrel assembly of the nail gun of the present invention while the firing pin is shifted to collide with the nails for sending out;

FIG. 7 is an exploded view of the barrel assembly of the nail gun of the present invention while the bush and the cover member are screwed with each other;

FIG. 8 is a cross-sectional view of the barrel assembly of the nail gun of the present invention after the bush and the cover member are assembled with each other;

FIG. 9 is an exploded view of the barrel assembly of the nail gun of the present invention while the bush and the cover member are engaged with each other;

FIG. 10 is a cross-sectional view of FIG. 9 after the bush and the cover member are assembled with each other; and

FIG. 11 is a partial cross-sectional view of a conventional nail gun.

### DETAILED DESCRIPTION OF THE INVENTION

To describe clearly that the present invention achieves the foregoing objective and function, the technical features and desired function are described with reference to a preferred embodiment and accompanying drawings.

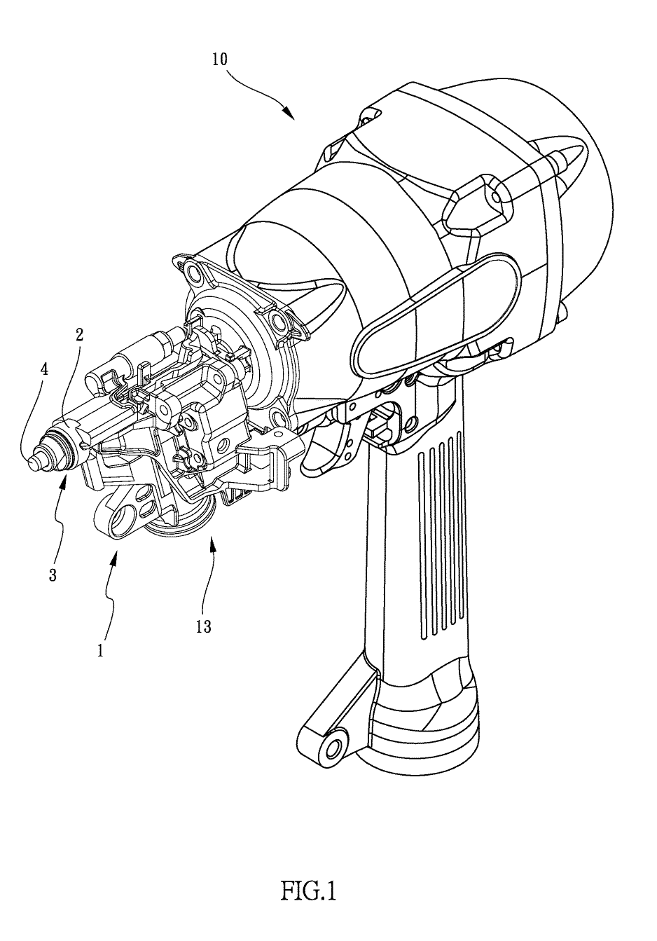

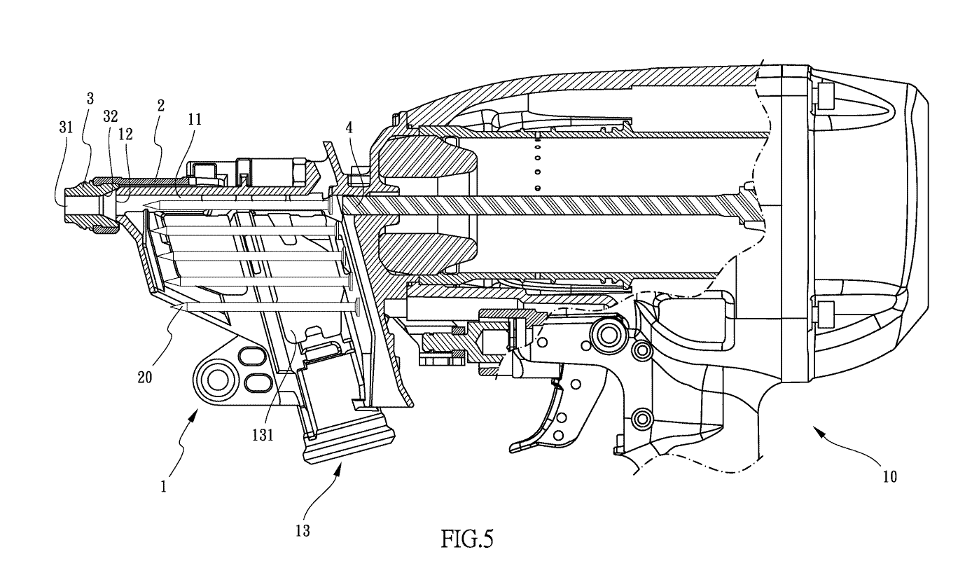

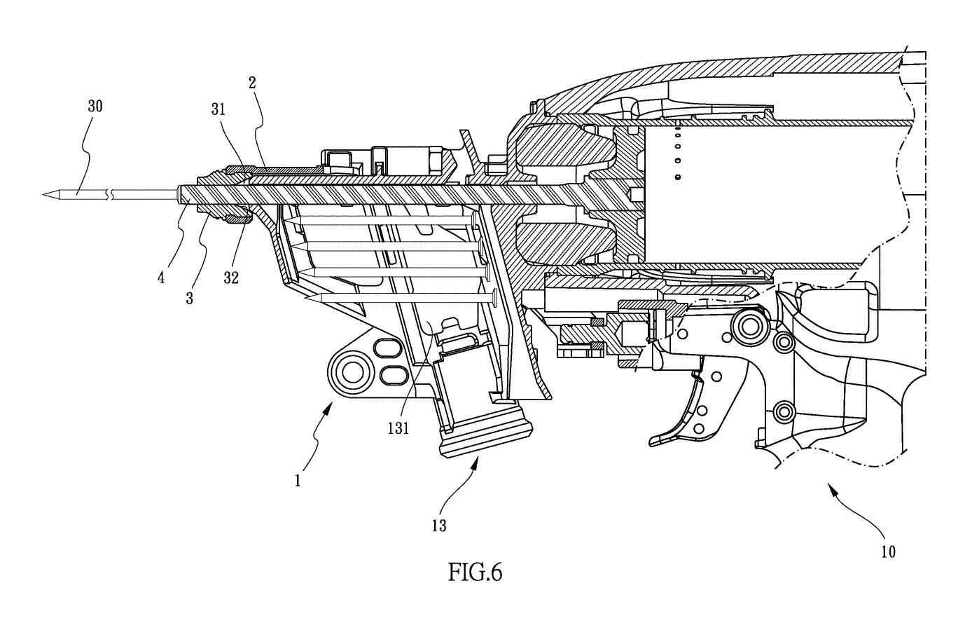

Please reference to FIGS. 1 to 6, a barrel assembly of a nail gun of present invention may be installed at a front end of a gun body 10 for transporting nails 20 to fire. The gun body 10 is prior art, therefore the detail descriptions are omitted. The barrel assembly may comprise a sleeve member 1, a cover member 2, a bush 3, and a firing pin 4. The sleeve member 1 may be connected with the front end of the gun body 10. The sleeve member 1 includes a chamber 11, a firing hole 12, and a transporting portion 13. The chamber 11 and the firing hole 12 are arranged at an upper part of the sleeve member 1, and the transporting portion 13 is arranged at a lower part of the sleeve member 1. The firing hole 12 is arranged at an end of the sleeve member 1 opposite to the gun body 10 and fluidly communicated with the chamber 11. The transporting portion 13 is arranged at a peripheral of the chamber 11. And a nail receiving groove 131 is further formed inside the transporting portion 13 for fluidly communicating with the chamber 11 and for receiving the nails. The cover member 2 may be covered at the end of the sleeve member 1 having the firing hole 12. An end of the cover member 2 corresponding to the firing hole 12 is further protruded from the sleeve member 1. And a fireproof groove 21 is formed at the cover member 2 corresponding to the firing hole 12 of the sleeve member 1. The bush 3 is cone cylindrical shape. Two ends of the bush 3 are respectively inserted into the fireproof groove 21 and protruded from the cover member 2. A limit hole 31 is further passing through the bush 3 for fluidly communicating with the firing hole 12. And the end of the sleeve member 1 having the firing hole 12 is inserted into the limit hole 31. Two ends of the firing pin 4 are respectively connected with the gun body 10 and inserted into the chamber 11 of the sleeve member 1. The gun body 10 is operated to drive the firing pin 4 to shift in the chamber 11, and further firing the nails 20 through the firing hole 12 toward the limit hole 31 of the bush 3 to send out.′

The above mentioned embodiment is the main skill feature of this invention and corresponds to the claim 1 of this invention to understand the objective and embodiments of this invention in detail. And the skill features of the depending claims are for describing the claim 1 in detail or adding more skill features, but not limited thereto. It should be known that the claim 1 is not necessary to include the skill features of the depending claims.

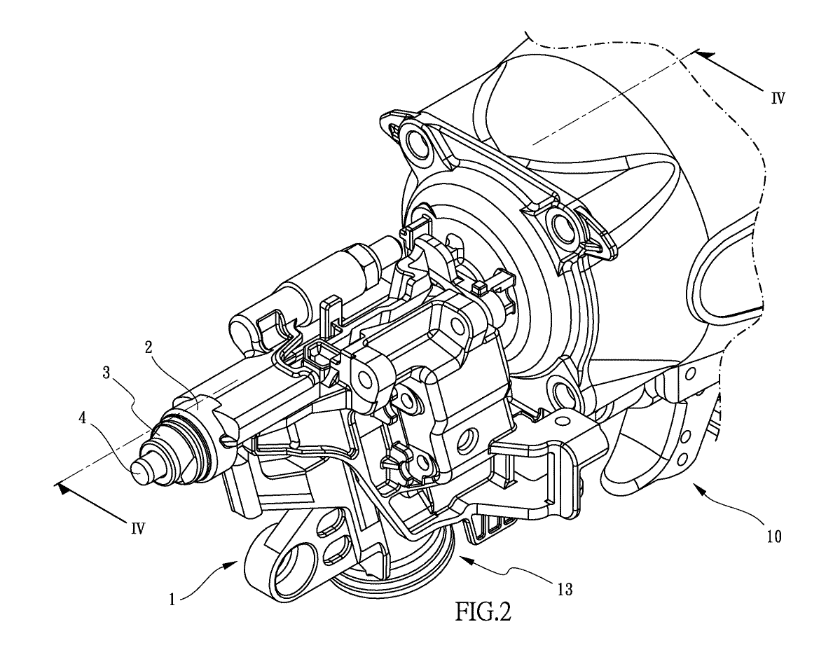

Please refer to FIGS. 2, 4, 5, and 6. When in operation, the nails 20 is arranged inside the nail receiving groove 131 through the transporting portion 13 and the gun body 10 is operated to drive the nails 20 to be transported from the nail receiving groove 131 toward the chamber 11. And when the nails 20 is transported into the chamber 11, the firing pin 4 may be shifted toward the gun body 10 and contracted. When the nails 20 are surely transported into the chamber 11, the gun body 10 is pressed and activated so as to shift the firing pin 4 which is contracted and eject toward the bush 3 after a user is definitely aiming at the object by the front end of the bush 3. After the ejection of the firing pin 4, the firing pin 4 is further colliding with the nails 20 arranged in the chamber 11 so that the nails 20 is fired out to press on the object by the fast collision power and the nail pressing operation is finished. However, according to above mentioned operation, the bush 3 may produce most benefits. The nails 20 may rub the chamber 11 while firing so as to heat the chamber 11 to a high temperature. The bush 3 is used to effectively limit the expansion and deformation of the firing hole 12 due to the high temperature so that the nails 20 will not be oblique outwardly while firing and after passing through the firing hole 12, or will not jam at the firing hole 12 to result in dangers and keep the precision and accuracy after firing and stability while continuing firing.

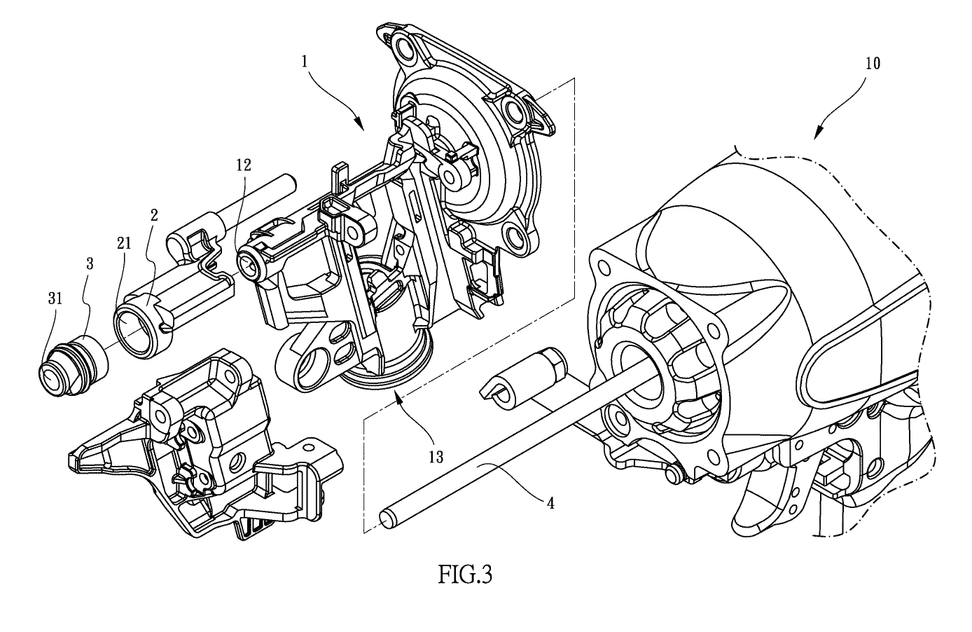

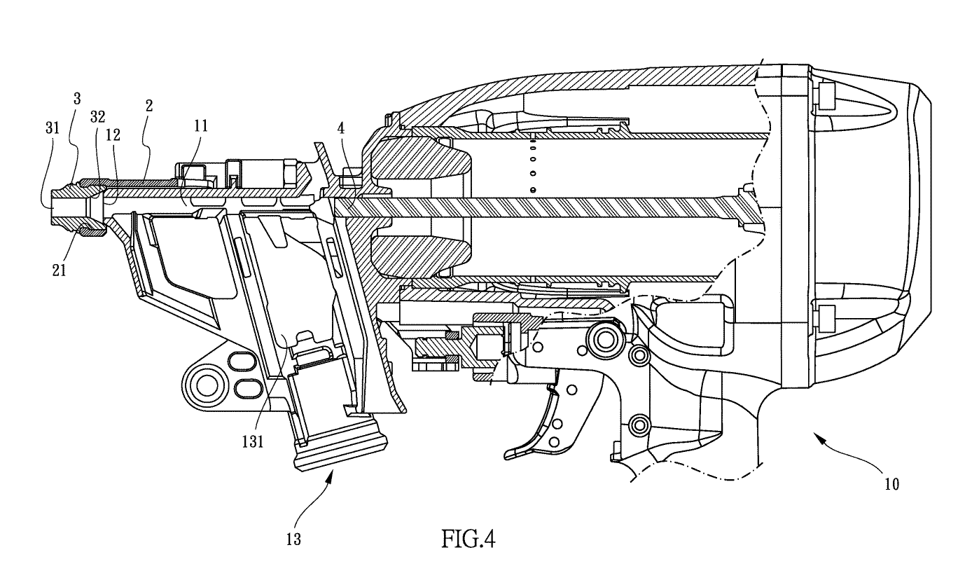

According to above mentioned assembly and effects of the bush 3 and the sleeve member 1, the detail characteristics of the bush 3 will be further described as follows. Please refer to FIGS. 3 and 4. In order to most effectively limit the expansion of the firing hole 12, a ring conical surface 32 is further formed at an inner wall of the end of the limit hole 31 of the bush 3 corresponding to the firing hole 12 (shown as in FIG. 4). That is, a diameter of the end of the limit hole 31 of the bush 3 corresponding to the firing hole 12 is larger than a diameter of the other end of the limit hole 31 opposite to the firing hole 12 which is tapered gradually to a predetermined diameter and then kept it to correspond to the diameter of the nails 20. The arrangement of the ring conical surface 32 makes the diameter of the end of the limit hole 31 corresponding to the firing hole 12 larger than the diameter of the other end of the limit hole 31 opposite to the firing hole 12. The end of the sleeve member 1 having the firing hole 12 is against the ring conical surface 32 so that the firing hole 12 may be limited by the limit hole 31 to prevent from overheating and deformation and further influencing precision, accuracy, and stability of firing. The bush 3 is made by the materials which are high temperature resistant and deformation resistant. Besides it may prevent from the expansion and deformation of the firing hole 12, it may also reduce the cost of the production of the sleeve member 1. It may be known that the length of the part of the sleeve member 1 arranged in the chamber 11 is shorter than the conventional nail gun due to the arrangement of the bush 3. That is, the amount of the materials may be reduced and the cost may be also reduced. It should be known that the bush 3 is not only for limiting and preventing from the expansion of the firing hole 12, but also for reducing the cost.

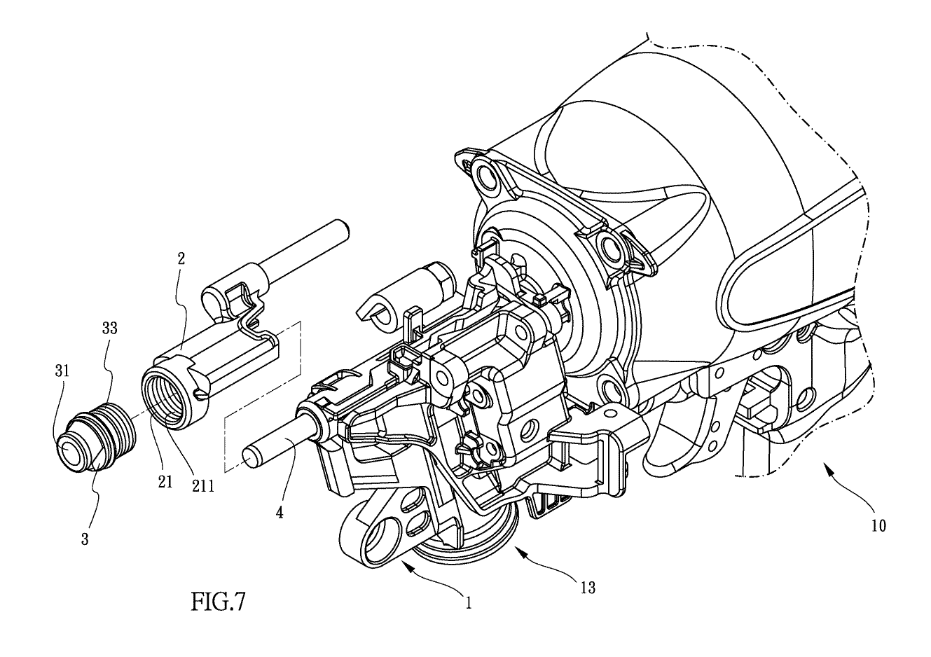

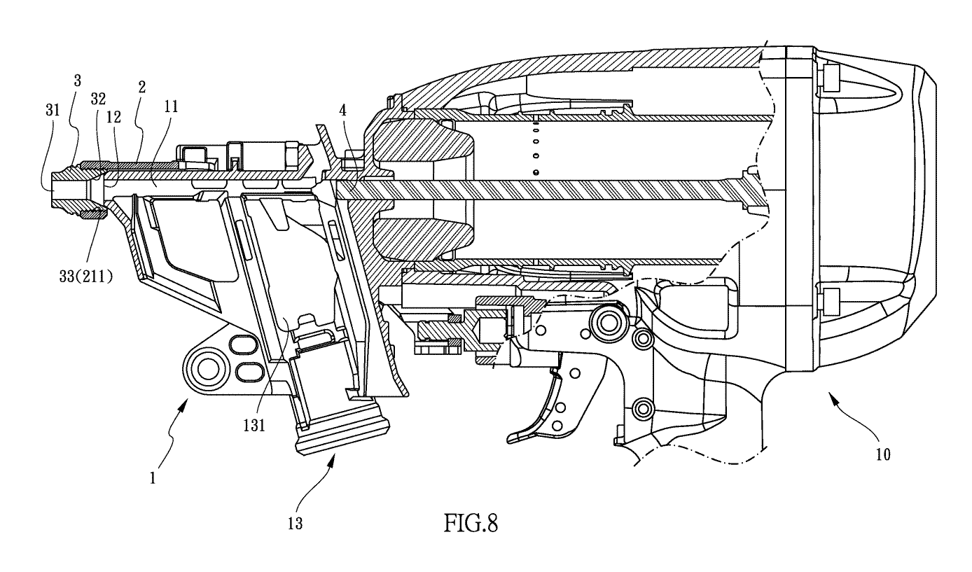

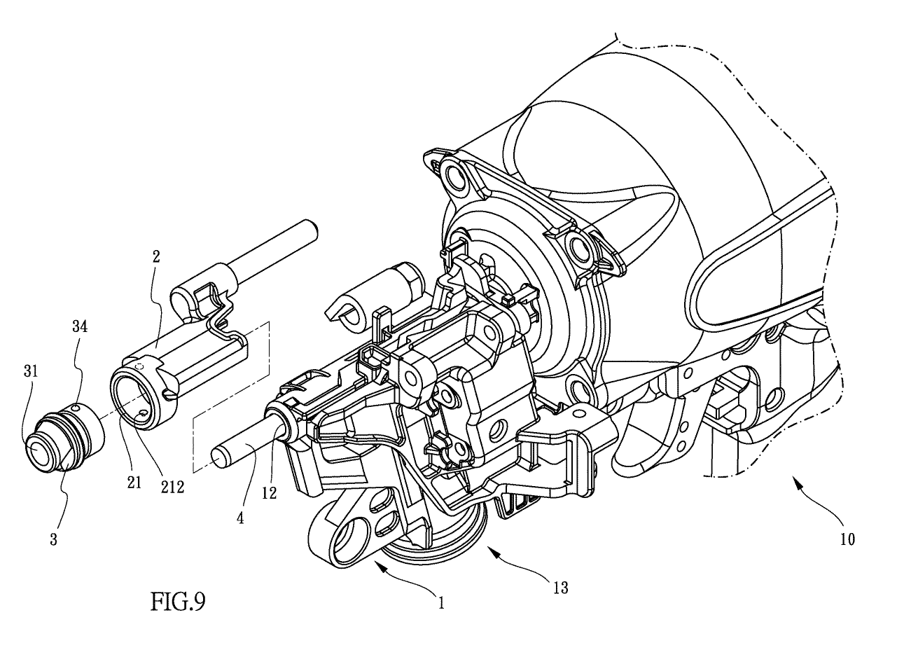

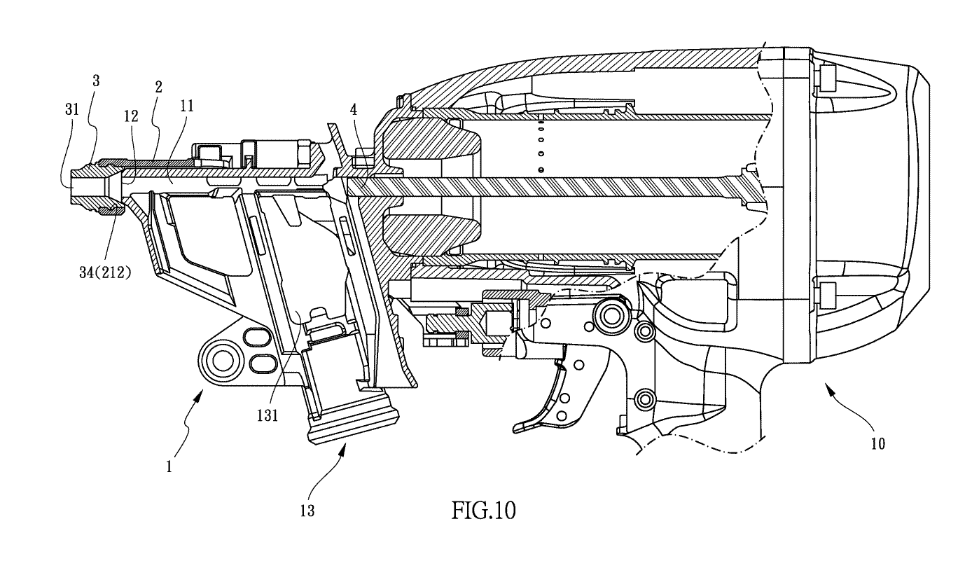

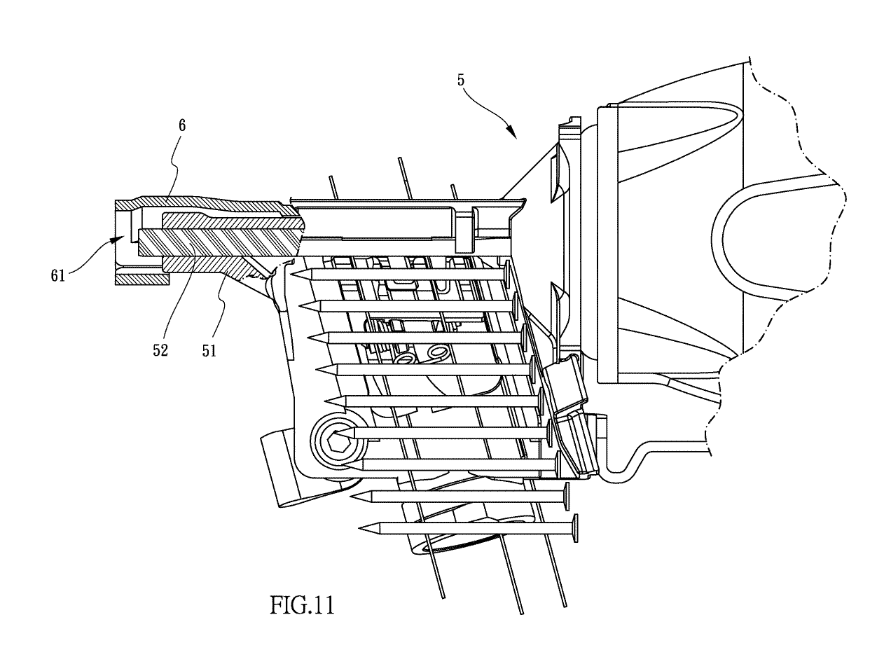

Besides above mentioned effects of the bush 3, there is another advantage of the bush 3 which is capable of providing quick and easy disassembly and repair. For the conventional nail gun, replacing the barrel 51 will take long time due to deformation of overheating the barrel 51 and disassembly of the elements of the barrel 51 one by one. The structure of the conventional nail gun is complicated and some users do not know how to disassemble. Furthermore, even after disassembling, the nails 20 will be oblique while firing to result in dangers if misassembling. Therefore, the barrel assembly of present invention may prevent from dangers and provide users to replace and repair easily. The bush 3 may provide users to replace and disassemble by themselves. The connection between the bush 3 and the cover member 2 may be screwing, engagement, or magnetic adhesion. Please refer to FIGS. 7 and 8, an outer thread 33 is formed at a peripheral of the end of the bush 3 inserted into the fireproof groove 21, and an inner thread 211 is formed at the fireproof groove 21 corresponding to the outer thread 33 for screwing with each other. Therefore, users may easily screw out or in the bush 3 from the cove member 2 to disassemble and assemble. Please refer to FIGS. 9 and 10, a flange 34 is formed at a peripheral of one end of the bush 3 inserted into the fireproof groove 21, and a slot 212 is formed at the fireproof groove 21 corresponding to the flange 34 for engaging with each other. The flange 34 and the slot 21 are arc shape for firmly engaging and easily replacing and disassembling. The above connections are for examples, but not limited thereto.

In conclusion, the deformation of the firing hole 12 may be limited due to the arrangements of the bush 3 and the limit hole 31 with the ring conical surface 32. Therefore, after the nails 20 is fired by the firing pin 4 which is controlled by the gun body 10, the nails 20 may be shot in the best path and direction, and further achieve the most precision and most stable shooting. Besides preventing from the deformation of the firing hole 12, it further provides easy replacement. Users may disassemble the bush 3 from the fireproof groove 21 to finish the disassembly. Compared to the conventional nail fun, the complicated disassembly is improved and the more time and man power are saved.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A barrel assembly of a nail gun, installed at a front end of a gun body for transporting nails, comprising:
a sleeve member, connected with the front end of the gun body, the sleeve member includes a chamber, a firing hole, and a transporting portion, the firing hole is arranged at an end of the sleeve member opposite to the gun body and fluidly communicated with the chamber, the transporting portion is arranged at a peripheral of the chamber, and a nail receiving groove is further formed inside the transporting portion for fluidly communicating with the chamber and for receiving the nails;
a cover member, covered at the end of the sleeve member having the firing hole, an end of the cover member corresponding to the firing hole is further protruded from the sleeve member, and a fireproof groove is formed at the cover member corresponding to the firing hole of the sleeve member;
a bush, two ends thereof are respectively inserted into the fireproof groove and protruded from the cover member, a limit hole is further passing through the bush for fluidly communicating with the firing hole, and the end of the sleeve member having the firing hole is inserted into the limit hole; and
a firing pin, two ends thereof are respectively connected with the gun body and inserted into the chamber of the sleeve member, the gun body is operated to drive the firing pin to shift in the chamber, and further firing the nails through the firing hole toward the limit hole of the bush to send out.

2. The barrel assembly as claimed in claim 1, wherein a ring conical surface is formed at an inner wall of the limit hole of the bush corresponding to the firing hole, a diameter of the end of the limit hole corresponding to the firing hole is larger than the other end thereof opposite to the firing hole, and the end of the sleeve member having the firing hole is against the ring conical surface to limit the expansion of the firing hole.

3. The barrel assembly as claimed in claim 1, wherein an connection between the bush and the cover member is screwing, engagement, or magnetic adhesion.

4. The barrel assembly as claimed in claim 2, wherein an connection between the bush and the cover member is screwing, engagement, or magnetic adhesion.

5. The barrel assembly as claimed in claim 3, wherein an outer thread is formed at a peripheral of one end of the bush inserted into the fireproof groove, and an inner thread is formed at the fireproof groove corresponding to the outer thread for screwing with each other.

6. The barrel assembly as claimed in claim 4, wherein an outer thread is formed at a peripheral of one end of the bush inserted into the fireproof groove, and an inner thread is formed at the fireproof groove corresponding to the outer thread for screwing with each other.

7. The barrel assembly as claimed in claim 3, wherein a flange is formed at a peripheral of one end of the bush inserted into the fireproof groove, and a slot is formed at the fireproof groove corresponding to the flange for engaging with each other.

8. The barrel assembly as claimed in claim 4, wherein a flange is formed at a peripheral of one end of the bush inserted into the fireproof groove, and a slot is formed at the fireproof groove corresponding to the flange for engaging with each other.
